(19) United States
(12) Patent Application Publication
(10) Pub. No.: US 2015/0241061 A1
(43) Pub. Date: Aug. 27, 2015

(54) HEAT SHIELD WITH A SUPPORTING STRUCTURE AND METHOD FOR COOLING THE SUPPORTING STRUCTURE

(71) Applicant: SIEMENS AKTIENGESELLSCHAFT, München (DE)

(72) Inventors: Andre Kluge, Dulmen (DE); Stefan Reich, Dusseldorf (DE); Daniel Vogtmann, Dusseldorf (DE)

(21) Appl. No.: 14/429,728

(22) PCT Filed: Sep. 17, 2013
(86) PCT No.: PCT/EP2013/069219

§ 371 Date: Mar. 19, 2015

(30) Foreign Application Priority Data
Sep. 21, 2012 (EP) 12185436.8

(51) Int. Cl. F23R 3/00; F02C 7/12

(52) U.S. Cl. CPC F23R 3/002; F02C 7/12

(57) ABSTRACT

A heat shield of a gas turbine: a supporting structure (16), to which heat shield tiles are fastened releasably by tile holders (2, 2a, 2b); The heat shield permits cooling of the supporting structure. Each tile has a cold side facing the supporting structure (16) and an opposite hot side that can be acted upon with a hot medium; each tile holder (2, 2a, 2b) has a holding section (3) for fastening to a heat shield tile and a fastening section (4) for fastening to the supporting structure (16). The fastening section (4) is fastenable at a fastening groove (18) running in the supporting structure (16). At least one cooling air duct (9) protects against hot gases. For the cooling purpose, in addition to the fastening grooves (18) at least one cooling air groove (1, 22) arranged in the supporting structure (16). The cooling air groove (1, 22) is partially covered in the longitudinal direction (7) of the cooling air groove (1, 22), at least when heat shield tiles are fastened to the supporting structure (16), thus forming a channel-shaped groove section (8) into which at least one cooling air duct (9) opens. Cooling air flowing out of the cooling air duct (9) is substantially deflectable in the longitudinal direction (7) of the cooling air duct (1,22).

### CROSS-REFERENCE TO RELATED APPLICATIONS

The present application is a 35 U.S.C. §§371 national phase conversion of PCT/EP2013/069219, filed Sep. 17, 2013, which claims priority of European Patent Application No. 12185436.8, filed Sep. 21, 2012, the contents of which are incorporated by reference herein. The PCT International Application was published in the German language.

### TECHNICAL FIELD

The invention relates to a heat shield with a support structure and to a method for cooling the support structure of a heat shield.

The invention also relates to a combustion chamber with such a heat shield and to a gas turbine.

### TECHNICAL BACKGROUND

Heat shields, which have to withstand hot gases of 1000 to 1600 degrees Celsius, are used in many technical applications. Particularly gas turbines, as are used in power-generating power stations and in aircraft engines, have correspondingly large surfaces inside the combustion chambers which are to be shielded by means of heat shields. Owing to the thermal expansion and owing to large dimensions, the heat shield has to be assembled from a large number of individual, generally ceramic, heat shield tiles which are fastened on a support structure and spaced apart with a sufficient gap. This gap provides the heat shield elements with sufficient room for thermal expansion. Since, however, the gap also enables direct contact of the hot combustion gases with the metal support structure and the retaining elements, cooling air is injected through the gaps in the direction of the combustion chamber as a countermeasure.

A generic-type heat shield therefore comprises a support structure and a number of heat shield tiles which are detachably fastened on the support structure by means of tile holders, wherein each heat shield tile has a cold side facing the support structure and a hot side which lies opposite the cold side and can be acted upon by a hot medium. Each of the tile holders has at least one retaining section for fastening on a heat shield tile and a fastening section which can be fastened on the support structure. The fastening section can be fastened in a fastening groove extending in the support structure. For protection against hot gases, at least one cooling air hole is provided in the support structure.

For fastening the tile holders on the support structure, provision can be made for annularly encompassing and parallel fastening grooves in the support structure. The tile holders in this case are inserted by their fastening sections one after the other into the fastening grooves, wherein successive tile holders lock the position of the previously positioned tile holders. In this way, an annularly encompassing row of heat shield tiles can be fastened on the support structure inside a combustion chamber of a gas turbine.

EP 1 701 095 A1 discloses a heat shield of a combustion chamber of a gas turbine with a support structure and a number of heat shield tiles which are detachably arranged on the support structure. For protection of the combustion chamber wall, the heat shield tiles are arranged in an extensively covering manner on the support structure, leaving expansion gaps, wherein each heat shield tile has a cold side facing the support structure and a hot side which lies opposite the cold side and can be acted upon by a hot medium. The heat shield tiles are fastened on the support structure in a sprung manner by means of two metal tile holders in each case. To this end, each tile holder comprises a retaining section, in the form of an engagement section, and a fastening section. Retaining grooves or pockets are introduced into each heat shield tile on two opposite circumferential sides so that for retention of the heat shield tiles, the engagement sections of the tile holders can oppositely engage in the retaining grooves. The tile holders which are oppositely fastened on the heat shield tile in such a way are guided by their fastening section in a fastening groove, extending beneath the heat shield tile, in the support structure. For protection against hot gases, the engagement sections of the metal tile holders are cooled. To this end, openings are introduced into the tile holders in the region of the retaining section and into the retaining latch of the heat shield tiles, which openings align with a cooling air hole which is arranged in the support structure so that cooling air from the cooling air hole, flowing in a direct line, impinges upon a cold side of the engagement section.

Despite this cooling of the engagement sections according to the prior art, with hot gas acting upon the heat shield, entry of hot gas in the region of the expansion gaps between the heat shield tiles can occur. The hot gas can then spread beneath the heat shield and lead to scaling of the support structure.

### SUMMARY OF THE INVENTION

It is therefore the object of the present invention to provide a heat shield with a support structure, a gas turbine with a combustion chamber having such a heat shield, and a method for cooling the support structure, by means of which scaling of the support structure on account of hot gas entry can be avoided in a particularly effective manner.

The object is achieved according to the invention in the case of a heat shield of the type referred to in the introduction by at least one cooling air groove being arranged in the support structure in addition to the fastening grooves. The cooling air groove, with heat shield tiles fastened on the support structure, is at least partially overlapped in the longitudinal direction of the cooling air groove so that a channel-like groove section, into which at least one cooling air channel opens, is formed so that cooling air flowing from the cooling air channel can be deflected in the main into the longitudinal direction of the cooling air groove.

By means of the heat shield according to the invention, cooling of the support structure is enabled.

An outflow direction is impressed upon the cooling air in the process by means of the arrangement of the cooling air channel and partially overlapped cooling air groove, which outflow direction avoids an impingement cooling of the heat shield tiles. As a result, the arrangement and the course of the at least one cooling air groove can be freely selected and in particular can also be guided beneath the heat shield tiles along the regions of the support structure which are especially important for the fastening of the heat shield tiles. This enables a particularly effective cooling of the support structure. The cooling air flowing from the cooling air channel can be deflected by means of the overlap into the longitudinal direction of the cooling air groove and therefore leaves the cooling air groove downstream of the overlap with a velocity component in the longitudinal direction of the cooling air groove. As a result of this oblique outflow direction of the cooling air from the cooling air groove, an advantageous introduction of the cooling air is enabled, avoiding an impingement cooling of the heat shield tiles.

The cooling air groove can especially extend in the support structure beneath a heat shield tile and introduce cooling air into the gap beneath the heat shield tile. The term “gap beneath the heat shield tiles and above the support structure” refers in this case to the gap which extends from the cold side of the heat shield tiles to the surface of the support structure which faces the cold side of the heat shield tiles. The term “support structure beneath the heat shield tile” refers to the region of the support structure which the cold side of the heat shield tile faces.

In the support structure, for example a plurality of cooling air grooves according to the invention can be arranged one after the other in rows or arranged separately from each other in a distributed manner over the support structure. The at least one cooling air groove can extend for example parallel to or inside a bottom of a fastening groove. They could, however, also be arranged in another region of the support structure. The cooling air in this case can be directed onto a region of the support structure which is preferably to be cooled. For example, the cooling air groove extends in the main centrally beneath a heat shield tile in a region in which at least one tile holder is fastened by its fastening section on the support structure because damage to this region in the worst case results in loss of the heat shield tile which is retained by the tile holder.

The cooling air groove can have a straight course or another course. The course is preferably straight, however, since such a cooling air groove can be introduced into the support structure in a particularly simple manner. If the cooling air groove has a curved course, the direction of the respective tangent to the course of the cooling air groove is identified by the longitudinal direction of the cooling air groove.

According to the invention, the cooling air groove is partially overlapped in the longitudinal direction so that a channel-like groove section is formed. Instead of the term “overlapped”, the term “covered” could also be used. The channel-like groove section is closed in the main so that the cooling air flowing from the cooling air channel can be effectively deflected into the cooling air groove.

The heat shield according to the invention can be realized for example by an air cooling channel, and a cooling air groove extending up to this channel, being introduced into the support structure so the cooling air channel opens into the groove and the cooling air groove is partially overlapped starting from the cooling air channel.

On account of its simple construction, the invention is especially also suitable for a subsequent introduction of the cooling air groove into an already installed heat shield. In this case, a cooling air channel which already exists in the support structure can be used for realizing the heat shield according to the invention.

It can be advantageously provided that the section of the cooling air groove which is not overlapped, with heat shield tiles arranged on the support structure, extends beneath the cold side of a heat shield tile and outside a region over which the tile holders project.

In this way, the cooling air flowing from the cooling air groove can flow into the gap beneath the heat shield and be distributed there. Therefore, the region of the support structure beneath the heat shield tile can be effectively cooled. The cooling air does not escape immediately through the expansion gaps which are arranged between the heat shield tiles.

It can also be seen to be advantageous that the cooling air groove is introduced into the bottom of a fastening groove. In this way, a particularly effective cooling of the sidewalls of the fastening groove, which serve for the fastening of the tile holders on the support structure, is made possible.

It can also be advantageously provided that the overlap is realized by means of the fastening section of a tile holder. This embodiment of the invention features a construction which is particularly easy to realize. The overlap of the cooling air groove is realized in this case by arranging a heat shield tile on the support structure, wherein a tile holder which retains the heat shield tile is brought into engagement with the fastening groove and is slid over the cooling air groove so that this is partially overlapped in the longitudinal direction. Additional components for overlapping of the cooling air groove are dispensed within this embodiment. This reduces the costs of such a heat shield.

An advantageous development of the invention can provide that the non-overlapped region of the cooling air groove extends in the bottom of the fastening groove in the region between two fastening sections of two oppositely disposed tile holders. The arrangement of the cooling air groove according to this development is particularly well suited to the cooling of the edges of the fastening groove which are provided for the fastening of the tile holders. According to this development, the cooling air groove, with heat shield tiles fastened on the support structure, extends in the main centrally beneath the heat shield tile.

It can also be advantageously provided that at least two cooling air grooves extending next to each other are arranged in the support structure, wherein the respective overlap of the cooling air grooves is arranged at opposite ends of the two cooling air grooves. The cooling air flowing from the two cooling air grooves therefore flows in opposite directions. This development of the invention enables a uniform distribution of cooling air over an area of the support structure.

It can also be advantageously provided that the cooling air channel opens into the cooling air groove essentially perpendicularly to the longitudinal direction of this. This orientation of the cooling air channel is to be introduced into the support structure in a particularly simple manner. The cooling air flowing from the cooling air channel therefore impinges perpendicularly upon a sidewall of the channel-like groove section which is arranged opposite the mouth and is deflected into the longitudinal direction of the cooling air groove. The sidewall can be an underside of a tile holder facing a bottom of the cooling air groove.

It can also be seen to be advantageous that the cooling air groove is in the main arranged centrally beneath the heat shield tile. This embodiment of the invention enables a particularly long residence time of the cooling air beneath the heat shield, avoiding an impingement cooling of the heat shield tile. Therefore, an effective cooling of the support structure arranged beneath the heat shield is enabled before the cooling air escapes through the expansion joints between the heat shield tiles.

It is a further object of the invention to provide a method for cooling the support structure of a generic-type heat shield, to avoid scaling of the support structure on account of entry of hot gas in a particularly effective manner.

To this end, at least one additional groove is introduced as a cooling air groove into the support structure in addition to the fastening grooves. A cooling air channel which opens into the cooling air groove is introduced into the support structure or is already arranged in the support structure. The groove is partially overlapped in the longitudinal direction so that cooling air flowing from the cooling air channel can be deflected by means of the overlap into the longitudinal direction of the cooling air groove.

This enables particularly effective cooling of the support structure, avoiding impingement cooling of the heat shield tiles.

What was said in relation to the heat shield according to the invention correspondingly applies with regard to the advantages and embodiment possibilities of the method.

With the method according to the invention, the support structure, especially in the region of the fastening sections of the tile holders, can be cooled in a particularly effective manner. The method can, for example, be applied within the scope of maintenance of an already installed heat shield by at least one additional groove being introduced into the support structure as a cooling air groove, in addition to the fastening grooves.

According to an advantageous development of the method, the cooling air groove may be introduced into the support structure in the region of a removed heat shield tile so that with the heat shield tile installed, cooling air flowing from the cooling air groove downstream of the overlap can flow into a gap between a cold side of a heat shield tile and the support structure.

In this case, it can be advantageously provided that the cooling air groove is introduced into a bottom of a fastening groove.

For the overlap of the cooling air groove, for example at least one tile holder can be slid by its fastening section over the cooling air groove so that this is partially overlapped in the longitudinal direction. The non-overlapped region of the cooling air groove extends in the main centrally beneath a heat shield tile which is retained by the tile holder.

The term “centrally” is not to be interpreted narrowly in this case. It refers to a region which is not located beneath an edge region of the heat shield tile.

It is a further object of the invention to provide a combustion chamber and a gas turbine with at least one combustion chamber, which enables particularly effective cooling of the support structure of a heat shield which is incorporated in the combustion chamber.

Further expedient embodiments and advantages of the invention are the subject matter of the description of exemplary embodiments of the invention with reference to the drawings, wherein the same designations refer to identically functioning components.

### BRIEF DESCRIPTION OF THE DRAWINGS

FIG. 1 shows a schematic perspective view of a cooling air groove and a tile holder of a heat shield according to the invention according to an exemplary embodiment,

FIG. 2 shows a schematic sectional view of a detail of the heat shield according to the invention in the region of a fastening groove and of the cooling air groove shown in FIG. 1, and

FIG. 3 shows a plan view of the detail shown in FIG. 2.

### DETAILED DESCRIPTION OF EMBODIMENTS

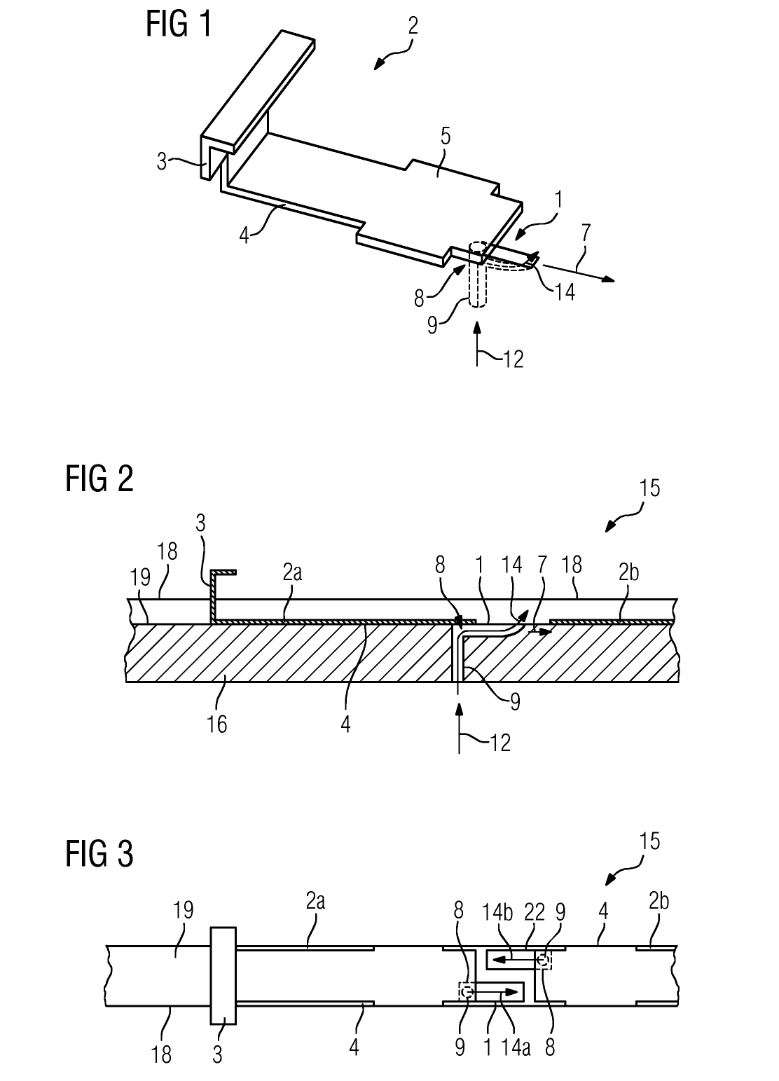

FIG. 1 schematically shows a cooling air groove 1 and a tile holder 2 according to an exemplary embodiment of the heat shield according to the invention. The tile holder 2 comprises a retaining section 3 which is arranged at right angles on a fastening section 4. The fastening section 4 is widened toward or at an end facing away from the retaining section 3 so that a so-called shoe 5 is formed.

The cooling air groove 1 extends in a longitudinal direction 7, wherein the cooling air groove is partially overlapped in the longitudinal direction 7 by the fastening section 4 so that the partially overlapped region of the cooling air groove forms a channel-like groove section 8. A cooling air channel 9 opens into the channel-like groove section 8. The cooling air channel 9 opens into the cooling air groove perpendicularly to the longitudinal direction 7. Cooling air, which flows through the cooling air channel 9 in the flow direction 12, makes its way into the channel-like groove section 8. On account of the overlap of the cooling air groove by means of the tile holder 2, cooling air is deflected into the longitudinal direction 7 of the cooling air groove so that the cooling air leaves the cooling air groove in an outflow direction 14 downstream of the channel-like groove section 8. The cooling air flow in this case has a velocity component in the longitudinal direction 7 of the cooling air groove. As a result of this oblique outflow direction 14 of the cooling air from the cooling air groove, an advantageous introduction of the cooling air is enabled, avoiding an impingement cooling of structures above the cooling air groove.

FIG. 2 shows a detail in a sectional view of a heat shield 15 according to the invention in the region of the cooling air groove 1 shown in FIG. 1. The heat shield 15 comprises a support structure 16, wherein the section of the view extends through a fastening groove 18 which is introduced into the support structure 16. A tile holder 2a and a tile holder 2b are arranged in the fastening groove 18 in the depicted section. The tile holders 2a, 2b rest in each case by their fastening section 4 on a bottom 19 of the fastening groove 18.

For fastening the tile holders 2a, 2b on the support structure 16, in the depicted exemplary embodiment, a widened section of the fastening section 4—the so-called shoe of the tile holder—engages with a close tolerance in a widening of the groove bottom which extends parallel to the surface of the support structure. The non-widened region of the fastening section 4 can be lifted without hindrance in the fastening groove 18. The retaining sections 3 of the tile holders, which are arranged perpendicularly on the fastening section 4, in each case project from the fastening groove 18 in this case and retain a heat shield tile, which is not shown. Since the tile holders generally consist of metal, in this way a heat shield tile which is retained by tile holders can be fastened in a sprung manner in the fastening groove 18.

A cooling air groove 1 is introduced into the support structure 16 in the bottom of the fastening groove 18. This is partially overlapped in the longitudinal direction 7 of the cooling air groove 1 in the depicted position of the tile holder 2a by the fastening section 4. The non-overlapped region of the cooling air groove 1 therefore extends in the bottom 19 of the fastening groove 18 in the region between two fastening sections 4 of two oppositely disposed tile holders 2a, 2b and beneath the cold side of a heat shield tile (not shown) which is retained by the two tile holders and outside a region over which the tile holders 2a, 2b project. In the depicted exemplary embodiment, the cooling air groove 1 also extends in the main centrally beneath a heat shield tile (not shown) which is retained by the tile holders 2a, 2b.

By means of the overlap, a channel-like groove section 8 is formed. A cooling air channel 9 opens into this groove section perpendicularly to the longitudinal direction 7.

Cooling air, which flows through the cooling air channel 9 in a flow direction 12 is deflected by means of the overlap into the longitudinal direction 7 of the cooling air groove 1 and leaves the cooling air groove 1 downstream of the overlap in an outflow direction 14 which is identified by an arrow by way of example. With a heat shield tile fastened on the tile holders 2a, 2b, the cooling air enters a gap between the cold side of the heat shield tile and the support structure, as a result of which an effective cooling of the support structure is enabled. An impingement cooling of the heat shield tile is reliably avoided in the process.

FIG. 3 shows the exemplary embodiment shown in FIG. 2 in a plan view. In this view, an additional cooling air groove 22 is arranged in the bottom 19 of the fastening groove 18 in addition to the cooling air groove 1 shown in FIG. 2. The two cooling air grooves 1, 22 extend next to each other in the support structure, wherein their overlaps are arranged at opposite ends of the cooling air grooves. The cooling air discharging from the two cooling air grooves therefore flows in opposite directions 14a, 14b and is distributed uniformly over the edge regions of the fastening groove 18 which serves for the fastening of the tile holders 2a, 2b. As a result of this, loss of a heat shield tile which is retained by the tile holders is prevented in a particularly effective manner.

1. A heat shield (15) for a combustion chamber of a gas turbine, with a support structure (16) and a number of heat shield tiles which are detachably fastened on the support structure (16) by means of tile holders (2, 2a, 2b), wherein each heat shield tile has a cold side facing the support structure (16) and a hot side which lies opposite the cold side and can be acted upon by a hot medium, and each tile holder (2, 2a, 2b) has at least one retaining section (3) for fastening on a heat shield tile and a fastening section (4) which can be fastened on the support structure (16), wherein the fastening section (4) can be fastened in a fastening groove (18) extending in the support structure (16), wherein for protection against hot gases provision is made for at least one cooling air channel (9),
characterized in that
at least one cooling air groove (1, 22) is arranged in the support structure (16) in addition to the fastening grooves (18), wherein the cooling air groove (1, 22), with heat shield tiles fastened on the support structure (16), is at least partially overlapped in the longitudinal direction (7) of the cooling air groove (1, 22) so that a channel-like groove section (8), into which at least one cooling air channel (9) opens, is formed so that cooling air flowing from the cooling air channel (9) can in the main be deflected into the longitudinal direction (7) of the cooling air groove (1, 22).

2. The heat shield (15) as claimed in claim 1,
characterized in that
the non-overlapped region of the cooling air groove (1, 22), with heat shield tiles arranged on the support structure (16), extends beneath the cold side of a heat shield tile and outside a region over which the tile holders (2, 2a, 2b) project.

3. The heat shield (15) as claimed in claim 1 or 2, characterized in that the cooling air groove (1, 22) is introduced into the bottom (19) of a fastening groove (18).

4. The heat shield (15) as claimed in claim 3,
characterized in that
the overlap is realized by means of the fastening section (4) of a tile holder (2, 2a, 2b).

5. The heat shield (15) as claimed in claim 3 or 4,
characterized in that
the non-overlapped region of the cooling air groove (1, 22) extends in the bottom (19) of the fastening groove (18) in the region between two fastening sections (4) of two oppositely disposed tile holders (2a, 2b).

6. The heat shield (15) as claimed in one of the preceding claims,
characterized by
at least two cooling air grooves (1, 22) extending next to each other in the support structure (16), the overlaps of which are arranged at opposite ends of the cooling air grooves (1, 22).

7. The heat shield (15) as claimed in one of the preceding claims,
characterized in that
the cooling air channel (9) opens into the cooling air groove (1, 22) essentially perpendicularly to the longitudinal direction (7) of this.

8. The heat shield (15) as claimed in one of the preceding claims,
characterized in that
the cooling air groove (1, 22) is arranged in the main centrally beneath the heat shield tile.

9. A method for cooling the support structure (16) of a heat shield (15), which comprises a number of heat shield tiles which can be detachably fastened on the support structure (16), wherein the heat shield tiles can be fastened on the support structure (16) in fastening grooves (18) by means of tile holders (2, 2a, 2b),
characterized in that
at least one additional groove is introduced into the support structure (16) as a cooling air groove (1, 22) in addition to the fastening grooves (18), wherein at least one cooling air channel (9), which opens into the cooling air groove (1, 22), is introduced into the support structure (16), or is already arranged in the support structure (16), and the cooling air groove (1, 22) is partially overlapped in the longitudinal direction (7) so that cooling air flowing from the cooling air channel (9) can be deflected by means of the overlap into the longitudinal direction (7) of the cooling air groove.

10. The method as claimed in claim 9,
characterized in that
the cooling air groove (1, 22) is introduced into the support structure (16) in the region of a removed heat shield tile so that with the heat shield tile installed cooling air flowing from the cooling air groove (1, 22) downstream of the overlap can flow into a gap between a cold side of a heat shield tile and the support structure (16).

11. The method as claimed in claim 9 or 10,
characterized in that
the cooling air groove (1, 22) is introduced into a bottom (19) of a fastening groove (18).

12. The method as claimed in claim 11,
characterized in that
for the overlap of the cooling air groove (1, 22) at least one tile holder (2, 2a, 2b) is slid by its fastening section (4) over the cooling air groove (1, 22) so that this is partially overlapped in the longitudinal direction (7), and the non-overlapped region of the cooling air groove (1, 22) extends in the main centrally beneath a heat shield tile which is retained by the tile holder (2, 2a, 2b).

13. A combustion chamber, which is lined by a heat shield (15),
characterized in that
the heat shield (15) is designed as claimed in one of claims 1 to 8.

14. A gas turbine with at least one combustion chamber,
characterized in that
at least one combustion chamber is designed as claimed in claim 13.
